(19) United States
(12) Patent Application Publication
(10) Pub. No.: US 2023/0391296 A1
(43) Pub. Date: Dec. 7, 2023

(54) Retractable Small-Engine-Machine Lifter for Mobile Repairs

(71) Applicant: Gavin Tran Bau Duong, Stouffville (CA)

(72) Inventor: Gavin Tran Bau Duong, Stouffville (CA)

(21) Appl. No.: 17/834,369

(22) Filed: Jun. 7, 2022

(51) Int. Cl. B60S 9/04

(52) U.S. Cl. CPC B60S 9/04

(57) ABSTRACT

The present disclosure provides a design for a retractable lifter that fits inside an existing vehicles' interior space for on-the-spot, small engine machine repairs (such as lawn mowers and snow blowers etc.). The retractable lifter comprises: a lifter platform that rotates along a pivot segment. The lifter platform has an adjustable wheel connector for vehicle track width adjustment and a plurality of pivotable trays for securing a machine's wheels. An arm assembly simultaneously expands and retracts and raises and lowers machines on the lifter platform using a remote-controlled, hydraulic system with two hydraulic cylinders. A support column moves the lifter platform outward, and the arm assembly extends downward to load a machine onto the platform. The lifter platform raises a machine to a desired height for repairs. An object of the lifter platform is to provide: improved convenience; speedy on-spot repairs; preserve space inside a vehicle; and increase adaptability to various different machines in less-than-ideal environments.

### CROSS-REFERENCE TO RELATED APPLICATIONS

This application claims the benefit of U.S. Provisional Patent Application No. 63/208,926 filed on Jun. 9, 2021.

### FIELD

The present disclosure is in the field of small engine machine on-spot mobile repair, mechanical engineering, hydraulic lifting systems, mobile lift, and especially, a retractable small-engine-machine lifter installed inside a service truck or van for the purpose of repairing small engine machines like snowblowers, lawn mowers, tractors, and other machines in a client's location.

### BACKGROUND

Lawn mowers and snow blowers are examples of machines with small internal combustion engines used at home or commercially. When they require maintenance or repairing work, e.g., oil changes, tire and part repairs or replacement, washing, blade changes, etc., such machines may be too heavy and/or large to be transported to a repair shop conveniently. Therefore, a means to repair those machines on the client's location (on-spot repairing) is required.

Normal jacks may be used for portable or at-home repairs. However, they are less useful for repairing smaller lawn mowers and snow blowers since they cannot raise the machine high enough to access the engine from the underside. In the case of two-wheeled snow blowers, car jacks simply cannot be properly placed to lift the entire machine.

A lift is more suitable for the purpose; however, lifts are usually larger and either stationary (i.e., car lift) or are not designed to travel long distances (i.e., forklift). Hereinafter, the term ‘lift’ is interchangeable with ‘lifter’. One exception is a lift table, which is a device that employs a scissors mechanism to raise or lower goods or persons; however, it still requires an individual to initially lift the lawnmower or machine to be repaired onto the table. Furthermore, the table platform is solid, preventing users from accessing the underside of the machine for engine repairing. Hereinafter, the term ‘user’ explicitly refers to an operator of the lifter and trained mechanic technician who repairs the small engine machines. Overall, there is a lack of lifts that can be ideally used for repairing machines at a customer's location.

Existing tools or machines for onsite repairs such as U.S. Pat. Nos. 7,278,627B2, 4,088,303A, US20110089389A1 and US20060278856A1 face several challenges that make them less ideal for repairing machines with small engines: (1) such tools or machines are considered ‘single-stage’ and only move in a single direction, typically up and down. A stage is a step in achieving a desired outcome. For example, existing lifts only move their platform from ground level to a certain height then to and forth. While these tools or machines are simpler to operate, they have limited flexibility and a smaller operational range. They are also slower and less efficient in performing their intended operations; (2) such tools or machines normally have a large footprint when they are not in use. In other words, they take up more space, such as the rear of a vehicle; (3) existing tools and machines have less flexibility and functionality for on-spot repairs. In other words, they are not adaptable for mobile repairs on the spot. For example, existing lift platforms have a fixed load supports width and cannot adjust track width for various small engine machines. Relating back to the example of the lift table, there is also no means to access the underside of the machine. Many existing machines and tools for on-spot repairs also do not have the flexibility to support repairing at various different directions and angles. They also have a larger footprint for storage and may be limited in performing repairs in less ideal environmental conditions (raining or snowing). Furthermore, the means of load support (i.e., platform) cannot be leveled on an angle for repair work in less ideal environments like uphill or downhill. Therefore, they need to be brought to a nearby flat location.

The present disclosure provides a new design that solves most of the above problems; this device takes the form of a retractable machine lifter for mobile repairs, primarily for snow blowers, lawn mowers, and tractors. The lifter moves horizontally and vertically to fast and easily load small engine machines. The device improves upon the following: (1) improved convenience for on-spot repairs; (2) highly efficient service vehicle space utilization; (3) increased service speed; (4) increased flexibility, functionality, and adaptability for small engine machines repair.

### SUMMARY

The present disclosure describes a new retractable small-engine machine lifter that can be installed inside a service vehicle, like a truck or van, with a small footprint for the purpose of repairing small engine vehicles or machines. The lifter takes the form of an adjustable lifter platform linked with a two-stage retractable lift arm assembly comprising an arm and support column on the side of the vehicle. An arm assembly is a two-stage machine that pivots up/down and moves forward/backward simultaneously to lift objects. The purpose of the designed lift device is to facilitate providing mobile repair services at a customer's location, especially repairing or maintenance work for lawn mowers, lawn tractors, snow blowers, and other small engine machines. There are a few aspects of the device include: (1) a two-stage dual-directional mechanism, which gives an extended range, faster speed, and more efficiency for the lifter to move; (2) a very small footprint when the lifter is fully retracted; (3) adjustability in the lifter platform for track width adjustment, tray length adjustment, rotation of various degrees along a support frame for repairing at various positions based on the environment, and pivoting trays for securing the wheels of small engine machines to prevent them from falling off the lift platform.

In the two-stage retractable lift arm assembly, the arm moves synchronously and simultaneously using a two-stage dual-directional mechanism; the first stage is the support column extends or retracts along an extension beam, and the second stage is the lifter arm pivots along the support column. In the preferred embodiment of the present disclosure, both stages are performed at the same time. The arm assembly can achieve this synchronous movement because the arm or column uses a remote-controlled hydraulic cylinder respectively. These two cylinders are simultaneously supplied with hydraulic fluid by a common power unit. The cylinder rods simultaneously push both the arm and support column. Additionally, the two-stage dual-directional mechanism allows the assembly to take up less space inside the vehicle and renders a quick and efficient lifter movement.

The adjustable lifter platform comprises multiple trays for loading machines to be repaired. The tray is large enough to hold an entire small tool or machine or used to just lift one of the front and back wheel tracks. The trays are attached to connectors situated on a sliding rod. Each tray is fitted to the connector with a locking rod, allowing the tray to pivot between a flat position along a vertical sagittal plane and a pivoted upward angle. Furthermore, a tray can be locked into any of the pivoted positions with a locking pin placed in the corresponding locking pin slot. At least one of the connectors can slide along the sliding rod to adjust the track width of the machine/tool to be repaired. The other connector is fixed to a pivot segment that allows the adjustable lifter platform to rotate 90 degrees horizontally in both clockwise and counter-clockwise directions (total 180 degrees) along a transverse plane. The rotation of the pivot segment and the adjustable lifter platform is done along the outer edge of the support frame. The support frame has a switch that lifts a locking pin. This allows restraint gear on top of the pivot segment to move freely, allowing the rotation of the adjustable lifter platform. The movements of the adjustable lifter platform components—particularly the trays, adjustable wheel connector, and pivot segment—improve the adaptability, flexibility, and functionality for the repair work.

By using this device described in the present disclosure, the overall experience of performing onsite repairs and maintenance for small engine machines is greatly improved: (1) it is more convenient to bring a lifter and all necessary repairing equipment in a smaller repairing vehicle to a client's location thanks to the smaller footprint of the novel lifter; (2) it saves space within the service vehicle due to the rotation of the adjustable lifter platform inward to fit neatly within the rear side of the vehicle. The saved space is also due to the two-stage dual-directional mechanism as a means to fit inside the vehicle and expand out to allow machines to be loaded; (3) the service speed is increased due to the efficiency and speed of the repair. This is due to the two-stage dual-directional mechanism reduces the time and number of operations/movements for lowering or raising the arm, as well as the overall setup of loading and unloading a small engine machine; (4) increased adaptability, flexibility, and functionality in regards to the types of machines thanks to sliding tray/connector to accommodate the various track widths. This improvement also applies to the type of environments and conditions that a repair can be carried out. This is because the lifter can now be adjusted and fixed at any angle, the adjustable lifter platform can be rotated to any degree up to 180, the trays can pivot up and down, and the distance between any two trays is also adjustable.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and, together with the description, serve to explain the principle of the present disclosure. For simplicity and clarity, the figures of the present disclosure illustrate a general manner of construction of various embodiments. Descriptions and details of well-known features and techniques may be omitted to avoid unnecessarily obscuring the discussion of the present disclosure's described embodiments. It should be understood that the elements of the figures are not necessarily drawn to scale. Some elements' dimensions may be exaggerated relative to other elements for enhancing the understanding of described embodiments. In the drawings:

FIG. 1 illustrates an overall view of a preferred embodiment of the retractable small-engine-machine lifter of the present disclosure in its extended position.

FIG. 2 illustrates a side and back view of the retractable small-engine-machine lifter of the present disclosure in its fully retracted position.

FIG. Three illustrates how the two-stage dual-directional mechanism works in a preferred embodiment of the present disclosure.

FIG. 4 illustrates how the adjustable lifter platform works in one embodiment of the present disclosure.

FIG. 5 illustrates a perspective view of the trays in the lifter platform that are adjusted in one embodiment of the present disclosure.

FIG. 6 illustrates how a retractable lifter of the present disclosure loads and elevates small engine machines for onsite repairs.

FIG. 7 illustrates a representative view of the method.

### DETAILED DESCRIPTION

The present disclosure generally relates to a small engine vehicle lifts and such a system that may take various forms. Various examples of the present disclosure are shown in the figures. However, the present disclosure is not limited to the illustrated embodiments. In the following description, specific details are mentioned to give a complete understanding of the present disclosure. However, it may likely be evident to a person of ordinary skill in the art; hence, the present disclosure may be applied without mentioning these specific details. The present disclosure is represented as few embodiments; however, the disclosure is not necessarily limited to the particular embodiments illustrated by the figures or description below. The language employed herein only describes particular embodiments; however, it is not limited to the disclosure's specific embodiments. The terms “they”, “he/she”, or “he or she” are used interchangeably because “they”, “them”, or “their” are considered singular gender-neutral pronouns. The terms “comprise” and/or “comprising” in this specification are intended to specify the presence of stated features, steps, operations, elements, and/or components; however, they do not exclude the presence or addition of other features, steps, operations, elements, components, or groups.

Unless otherwise defined, all terminology used herein, including technical and scientific terms, have the same definition as what is commonly understood by a person of ordinary skill in the art, typically to whom this disclosure belongs. It will be further understood that terms, such as those defined in commonly used dictionaries, should be interpreted as having the same meaning as defined in the context of the relevant art and the present disclosure. Such terms should not be construed in an overly strict sense unless explicitly described herein. It should be understood that multiple techniques and steps are disclosed in the description, each with its own benefit. Each technique or step can also be utilized in conjunction with a single, multiple, or all of the other disclosed techniques or steps. For brevity, the description will avoid repeating each possible combination of the steps unnecessarily. Nonetheless, it should be understood that such combinations are within the scope of the disclosure. Reference will now be made in detail to some embodiments of the present disclosure, examples of which are illustrated in the accompanying figures.

The present disclosure provides a new method and device in the form of a retractable lifter that improves mobile repairs for small engine machines. The device can be installed in a service vehicle like a van or truck. In one preferred embodiment of the present disclosure, the new device is situated in one side of the vehicle's cargo space, typically the left side wall, when facing the rear of the vehicle. Hereinafter, the term ‘vehicle’ explicitly implies a ‘service vehicle’, ‘van’, or ‘truck’, and all the terms will be used interchangeably. The device comprises an adjustable lifter platform comprising at least two trays connected to two connectors (one tray connects to one connector) via locking rods. Hereinafter, the term ‘adjustable lifter platform’ is interchangeable with ‘lift platform’, ‘lifter platform’, and simply ‘platform’. The connector closest to the vehicle is fixed or welded to a pivot segment, while the other connector freely moves along a sliding rod. The pivot segment can rotate the platform 180 degrees along a horizontal transverse plane. This rotation is done along the front edge of a support frame that serves as an attachment point for the lifter platform and a two-stage retractable lift arm assembly. The rotation of the lifter platform is determined by a switch on the side of the support frame, an attached locking pin, and a restraint gear.

The lifter can be elevated vertically and extended inward/outward from the vehicle using a two-stage retractable lift arm assembly comprising a hydraulic arm and support column. Hereinafter, the term ‘two-stage retractable lift arm assembly’ is interchangeable with ‘arm assembly’; the terms primarily imply the mechanical components such as the arm, support column, pivoting bracket, extension beam, and fixed horizontal bracket. As earlier noted, the support frame serves as an intermediate attachment point between the lifter platform and this arm assembly. The arm itself comprises two link members, which pivot along both the support column and support frame. The support column moves with the extension/retraction of an extension beam from within a fixed horizontal bracket on the vehicle floor. Hereinafter, the term ‘support column’ is interchangeable with ‘column’. The retractable lift arm assembly is hydraulically powered via hydraulic cylinders and hydraulic cylinder rods. Hereinafter, the term ‘hydraulic cylinder’ is interchangeable with ‘cylinder’, and the term ‘hydraulic cylinder rod’ is interchangeable with ‘cylinder rod’ or ‘rod’. The hydraulic system has a power unit comprising an electric motor and a reservoir. Hereinafter, the term ‘hydraulic power unit’ is interchangeable with ‘power unit’. This power unit is controlled by a terminal via a wireless or wired remote.

Although the lifter is primarily suited for lawn mowers, snow blowers, and lawn tractors, the device may also be applicable for the repair of other small engine machines such as pressure washers, portable generators, all-terrain vehicles and other tools and machines.

The present disclosure itself has a few notable aspects. In the first aspect of the present disclosure, the lifter arm and support column move together to complete the arm extension and retraction. Hereinafter, this mechanism is called ‘two-stage dual-directional mechanism’. With this mechanism, the support column moves inward and outward along the vehicle's interior wall with a translation motion. This motion is guided by an extension beam situated on the vehicle floor. At the same time, the arm moves along a vertical sagittal plane to pivot along joints that connect the arm to the support column. The arm also pivots along joints connected to the support frame during this movement, which keeps the support frame and platform leveled. A hydraulic system powers both movements via hydraulic cylinders: one perpendicular to the column and another above the arm. More specifically, the associated hydraulic cylinder rods extend or retract from the hydraulic cylinders, which ultimately push or pull the arm and column. The movement of the cylinder rods is determined by the addition or removal of hydraulic fluid from the cylinders via hydraulic hoses. Hereinafter, the term ‘hydraulic fluid’ is interchangeable with ‘hydraulic oil’ and ‘fluid’. The hydraulic system is powered by a hydraulic power unit consisting of a reservoir and an electric motor. A terminal is connected to the power unit via a cable, which activates the power unit by supplying it with electrical power. The terminal is connected to a wireless remote that sends instructions to the terminal to activate the power unit. Once powered, the power unit's motor activates to trigger the extraction of hydraulic fluid from the reservoir to the hydraulic cylinders via hydraulic hoses.

It should be noted that, in this aspect of the present disclosure, the cylinder rod controlling the movement of the arm pivots along a joint connected to the arm's middle section. The cylinder itself rotates to govern the arm's movements; it is covered by a pivoting cover bracket that pivots along a joint connected to the upper section of the support column. This synchronous movement is part of the novel mechanism, as it further facilitates the arm's movement.

In the second aspect of the present disclosure, the lifter has a very small footprint, particularly when it is fully retracted. The lifter is located on only one side of the vehicle. In the present disclosure, it is on the left rear side of the vehicle's interior space when facing the rear of the vehicle. In its retracted position, the arm assembly and the lifter platform are brought into the vehicle's interior space. The column is pulled into the vehicle's interior space with the retraction of the extension beam, which is caused by the retraction of the associated hydraulic cylinder's rod. The arm is lifted to an upward angle; the arm's length is nearly aligned to the support column's length. The vertical movement of the arm is caused by the retraction of the associated hydraulic cylinder's rod. This particular cylinder is attached to the support column via a pivoting cover bracket, which pivots along a joint connected to the support column during the arm's retraction.

In the third aspect of the present disclosure, the lift platform and its features are flexible and adjustable to adapt to different repair scenarios. The lift platform has notable features: (1) one of the connectors—an adjustable wheel connector—can slide along the metal rod. The loading track width can be adjusted when the adjustable wheel connector slides away or toward the fixed wheel connector. Naturally, the tray connected to the adjustable wheel connector also moves. This track width adjustment is made to accommodate the different track widths of different types and models of small engine machines (i.e., lawn mowers, snow blowers, and tractors); (2) the trays can pivot from the ground on an upward angle as they individually pivot along their associated locking rods. A pivoted tray can be locked into the desired angle using a locking pin placed in one of two locking slots on the outward side of the connector. This allows a small engine machine to be loaded at a level against the horizon; (3) the lift platform is welded to a pivot segment. More specifically, the fixed wheel connector is welded in between the top and bottom sections of the pivot segment. The pivot segment and attached platform can rotate 180 degrees horizontally along a transverse plane at the front edge of a support frame. This movement is dictated by the components of the support frame: a switch, a restraint gear on top of the pivot segment, and a locking pin inside the support frame behind the pivot segment and restraint gear. A switch is located inside the support frame, which protrudes out the side of the support frame. When facing the rear of the vehicle, the switch protrudes on the right side of the support frame. The switch is initially pivoted at a certain angle. The switch is then lifted to a horizontally flat position, which raises the locking pin from its original location. In doing so, the restraint gear is freed. This lets the pivot segment and platform rotate as long as the switch and the locking pin are lifted upward and held in place. Once released, the locking pin and switch go back to their original positions to lock the pivot segment and the platform in place.

The retractable small-engine-machine lifter addresses problems previously found in existing lifts and on-spot repair machines. First, it increases service speed, making repairs quicker and more efficient. This is thanks to the first aspect of the present disclosure, the two-stage dual-directional mechanism. The simultaneous movement of the arm and support column is achieved when the hydraulic cylinder and rods act on the moving components at the same time. The hydraulic system is designed in a way that simultaneously controls hydraulic fluid levels in the cylinders, ultimately allowing the lifter to perform its action in a single step. On the other hand, many existing machines used for lifting would first need to extend outward and then downward. As such machines retract, it needs to move upward and then inward. Furthermore, most existing machines for lifting are only single-stage, meaning that they can only move vertically or move inward/outward.

Second, the device provides improved convenience for both the customer and the operator/user. Because the lifter can be stored inside a vehicle, the lift can be brought to a customer's location at any time. Moreover, the customer does not have to lift the machine into their own vehicle and bring it to the shop, effectively saving time. The improved convenience also eases the entire operational process. First, the user only needs to press a button on the remote to bring the lifter outward and downward. Relating back to the first aspect of the present disclosure, the two-stage dual-directional mechanism simplifies the operation in extending or retracting the lift into one easy step, effectively saving time. When the lifter is extended downward, the user just moves the machine onto or away from the lifter platform. In the third aspect of the present disclosure, this convenience is also influenced by the adjustability of the lift platform and, in turn, can increase the adaptability for repair work. Essentially, more customers can be serviced since the lift platform can accommodate different types of small engine machines. Furthermore, the increased adaptability for repair work also addresses the need to do repairs in less ideal environments (i.e., sloped surface, uneven terrain, etc.). The user can also adjust the lifter to a level and angle that is comfortable for them using the first and third aspects of the present disclosure. The user can extend the arm out to an ideal vertical level, and they can rotate the adjustable platform to an angle best suited for repairs. Relating back to the first aspect, the novel mechanism also gives an increased range during lifter movement, which allows a user to have more space to move around and do repair work.

Third, the device allows for increased interior space for the accommodating vehicle. In the second aspect of the present disclosure, the device has a very small footprint when the lifter is fully retracted. The lifter is generally located on only one side of the vehicle's interior space. When fully retracted, the two-stage retractable arm assembly is brought into the vehicle's interior space. The arm is raised to a level that is approximately in line with the support column, further reducing the space the lifter occupies. The small footprint and increased interior space are also achieved with the third aspect of the present disclosure, the adjustability of the lift platform. The lift platform is fixed to a pivot segment, which rotates 180 degrees along the front edge of the device's support frame. To take advantage of the small footprint, the lift platform can be rotated inward so that the trays face toward the vehicle's interior space. As a result, the entire lifter does not protrude from the rear of the vehicle. Furthermore, the adjustable wheel connector can slide along the sliding rod to further save space. Because the lifter takes up little space, a workbench can be allocated next to the lifter. This space improvement also improves the convenience of repair mentioned above since a user has access to additional tools needed at the workbench for repairs equivalent to that of a typical brick-and-mortar setup. At last, the small device footprint also makes the service vehicle can be a smaller sized van or truck; this can make the repairing service even more convenient and mobile.

Fourth, the device provides increased adaptability for performing repair work. In the third aspect of the present disclosure, the adjustability of the lift platform lets one of the two connectors—an adjustable wheel connector—slide along the sliding rod. Naturally, the tray attached to this connector also moves with this action. In doing so, the track width of the platform can be adjusted to accommodate a large number of small engine machines with different track widths. The platform generally allows flexible placement of small engine machines for repair, whether the machine is fully placed on the platform (e.g., smaller lawn mowers and snow blowers) or only one set of wheels is on the platform (e.g., larger lawn tractors). Relating to the first and third aspects of the present disclosure, repair work can be done in less ideal environments in the following ways: (1) the two-stage dual-directional mechanism can move the retractable arm assembly to a certain level best suited for the repair work at hand. This can be used if the repair environment is on a sloped or uneven surface; (2) the platform's adjustability allows the platform to rotate 180 degrees horizontally along a transverse plane to an ideal position. This can be done to obtain optimal lighting conditions, to move away from obstructions (e.g., debris or moving traffic), or for any other applicable circumstances. The pivoting trays can also be locked in place by inserting a locking pin into one of two locking pin slots on the side of the connector. The pivoting movement of the trays can be used to secure the wheels of a small engine machine onto the lifter platform, reducing the risk of the machine falling from the lifter. By increasing the adaptability for repair work, the device also improves convenience and saves service repair time. This is because there is no need to move the machine, lifter, and service vehicle to a different location for repairs.

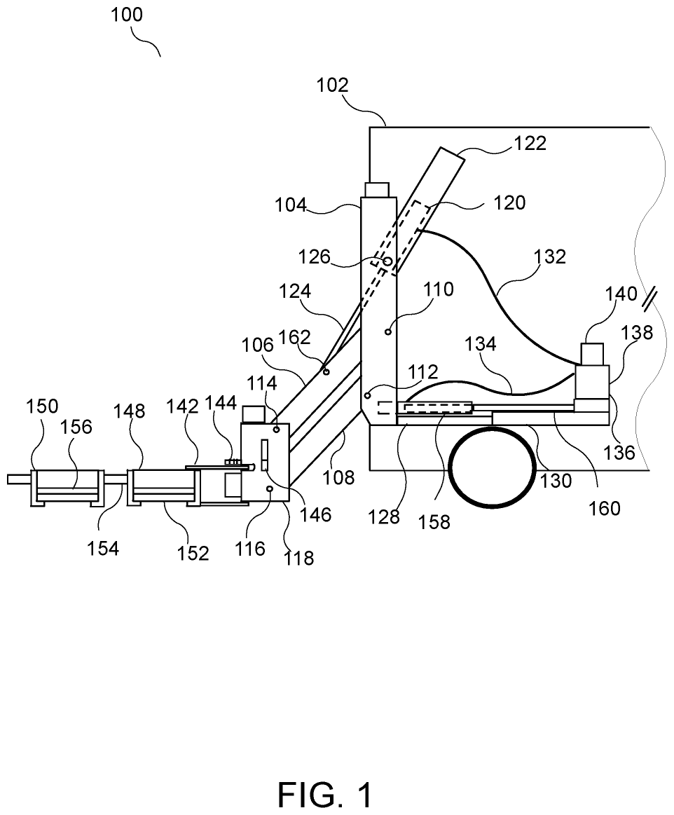

FIG. 1 illustrates an overall view of a preferred embodiment of the retractable small-engine- machine lifter of the present disclosure in its extended position. The figure generally illustrates a side view of the lifter with the vehicle on the right side and the lifter platform extended on the left side. The lifter is located within the interior walls of a vehicle (102); more specifically, the lifter is secured to a side wall of the vehicle (102). A hollow support column (104) of the arm assembly is pushed outward by an extension beam (128) extended out from a hollow fixed horizontal bracket (130). This movement is caused by a horizontally placed hydraulic cylinder (158); both the cylinder (158) and the extension beam (128) are pushed by the extension of the hydraulic cylinder rod (160), which in turn pushes the support column (104) outward. In its fully extended state (100), the front end of the support column (104) slightly protrudes out from the edge of the vehicle's (102) rear.

At approximately the same time, the arm of the retractable arm assembly, consisting of an upper link member (106) and a lower link member (108), moves down to the lower lifter platform. The inner end of the arm (106, 108) is connected to the column (104) via joints (110, 112) on the support column (104): the upper link member (106) is pivotally connected to joint (110), and the lower link member (108) is pivotally connected to joint (112). The inner ends of the upper (106) and lower (108) link members pivot downward along their respective joints (110, 112) to achieve the downward movement of the arm (106, 108) and the lifter. The outer end of the arm (106, 108) is connected to a hollow support frame (118) via joints (114, 116) on the support frame (118): the upper link member (106) is pivotally connected to joint (114) at the top rear of the support frame (118); the lower link member (108) is pivotally connected to joint (116) at the bottom middle of the support frame (118). The outer ends of the upper (106) and lower (108) link members pivot downward along their respective joints (114, 116). This allows the support frame (118) and the rest of the platform to remain horizontally leveled as it moves downward.

The vertical movement of the arm (106, 108) is caused by a hydraulic cylinder (120) and its cylinder rod (124) above the arm. Hydraulic cylinder (120) is covered by a hollow pivoting cover bracket (122); cylinder (120) and the pivoting cover bracket (122) are situated within the hollow space of the support column (104), particularly at its upper section. The pivoting cover bracket (122) is pivotally connected to the support column (104) via joint (126) and pivots along that joint (126). Both the pivoting movement of hydraulic cylinder (120) and the extension of cylinder rod (124) act together to push or pull the arm (106, 108) upward or downward. Additionally, the outer end of cylinder rod (124) is pivotally connected to the middle of the arm's (106, 108) upper link member (106) via joint (162) to further facilitate the movement of the arm (106, 108).

The lifter platform itself comprises several components. There are two trays (152): one tray (152) is connected to a fixed wheel connector (148), and another tray (152) is connected to an adjustable wheel connector (150). Both trays (152) are connected to the connectors (148, 150) via locking rods (156). The trays (152) are supported by the bottom edges of the connectors (148, 150). A sliding rod (154) holds the trays (152) and connectors (148, 150) in place. The fixed wheel connector (148) is welded to a hollow pivot segment (142) next to the support frame (118). The upper portion of the pivot segment (142) overlaps the top of the fixed wheel connector (148), while the lower portion is aligned with the base of the fixed wheel connector (148). The upper portion of the pivot segment (142) fits within a slot of the support frame (118), while the bottom portion of the pivot segment (142) overlaps the base of the support frame (118). A switch (146) on the side of the support frame (118) allows the pivot segment (142) to rotate the entire lifter platform; the switch (146) works with a restraint gear (144) on the upper portion of the pivot segment (142) to control this rotational movement.

The hydraulic cylinders (120, 158) connect to a hydraulic power unit (136) that supplies hydraulic oil to the cylinders (120, 158) via hydraulic hoses (132, 134): hydraulic cylinder (120) connects to hydraulic hose (132), and hydraulic cylinder (158) connects to hydraulic hose (134). The hydraulic power unit (136) consists of a reservoir (138) and an electric motor (140).

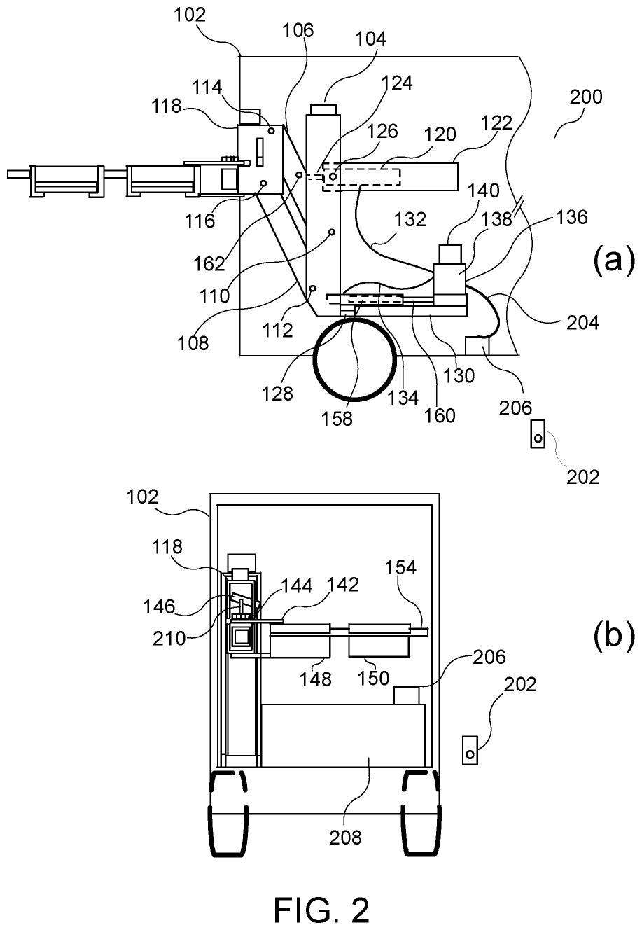

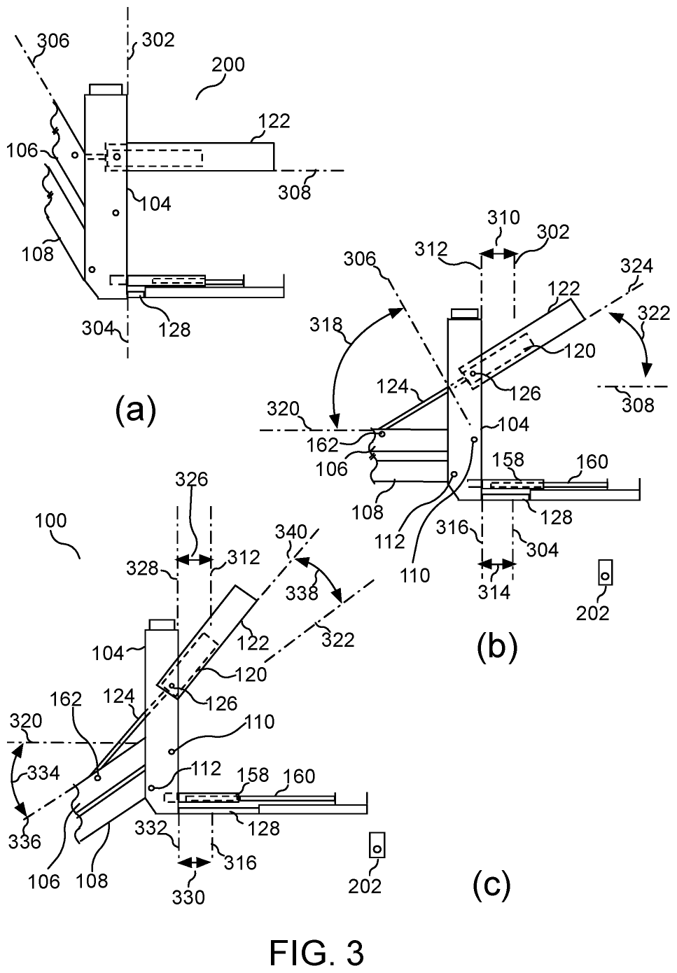

The arm (106, 108) and support column (104) are brought out simultaneously thanks to the novel two-stage dual-directional mechanism. In this mechanism, both hydraulic cylinders (120, 158) are supplied with hydraulic fluid from the power unit's (136) reservoir (138) at the same time. As a result, the downward extension can be done with one single action to increase service speed. The mechanism can also provide convenience to the user since the small engine machine on the platform (142, 144, 148, 150, 152, 154, 156) can be brought to a preferred level. Furthermore, the simultaneous movement of the arm (106, 108) and support column (104) from the novel mechanism also provides an increased range during lifter movement, giving a user more space to move around and do repair work. The simultaneous movement is also used to decrease the device's footprint for increased space inside the vehicle; this will be explained in future paragraphs and in FIG. 2.

The hydraulic system shows a general outline of the hydraulic cylinders (120, 158) connecting to the hydraulic power unit (136) via hydraulic hoses (132, 134). In one embodiment, the hydraulic system may use single-acting cylinders with only one port; hydraulic fluid enters and exits one side of the cylinder (120, 158) through a single port via one hydraulic hose (132, 134). In another embodiment, the system uses double-acting cylinders with two ports: one on each side of the cylinder (120, 158). Hydraulic fluid in a double-acting cylinder is present on both sides of the cylinder (120, 158). When the rod (124, 160) retracts, hydraulic fluid enters the rod (124, 160) end of the cylinder (120, 158) via one port, while fluid exits the opposite end of the cylinder (120, 158) through another port. When the rod (124, 160) extends, hydraulic fluid exits the rod (124, 160) end, while fluid enters the opposite end.

A hydraulic system to power the two-stage dual-directional mechanism is beneficial because a large amount of pressure is generated from the cylinders (120, 158), making it better for heavy-duty applications such as lifting small machine engines. In an alternative embodiment, the system that powers the two-stage dual-directional mechanism may use a purely electrical system with electrical cylinders. The benefits of an electric system include, but are not limited to: safer, cleaner, more efficient, cheaper, lower maintenance, longer service life, and easy installation.

In another alternative embodiment, the mechanism may operate using a pneumatic system with compressed gas. In one sense, a pneumatic system may help the device achieve the second aspect of a smaller footprint since pneumatic systems take up even less space compared to a hydraulic system. It is also cheaper. However, more maintenance is required for a pneumatic system.

In yet another alternative embodiment, the hydraulic system can be adjusted so that the arm (106, 108) and support column (104) move synchronously but not simultaneously. Rather than moving at the same time, one component, either the arm (106, 108) or support column (104), moves first. While one component moves, the other component starts moving shortly after. For example, the arm (116, 118) can move downward first via hydraulic supply. When the arm (116, 118) is moved downward by a certain angle, hydraulic fluid is supplied to cylinder (158). Then, rod (160) extends from cylinder (158) to push the column (104) outward. The timing of the individual movements for the arm assembly's components may be adjusted accordingly to the user's preferences. By using this alternative embodiment, the two-stage dual-directional mechanism is still achieved since the components still move together without waiting for one component to completely transition to the position dictated by the extended state (100).

In yet another alternative embodiment, the two-stage dual-directional mechanism can be configured in a way that can move the arm (106, 108) or column (104) independently as needed to add further customization in regards to positioning. In a way, this may help further improve the convenience of repair work and increase adaptability for repair work in less ideal environments.

The arm (106, 108) used in the present disclosure has two link members: one upper (106) and lower (108). In an alternative embodiment, the arm (106, 108) may have a single link member that pivots along a support column and another link member attached to the former link member via an elbow joint. Using this type of arm may extend the arm's (106, 108) reach when extending the lifter downward.

The rotation of the adjustable lifter platform (142, 144, 148, 150, 152, 154, 156) is one of the

key aspects of the present disclosure. The aspect comprises the platform's (142, 144, 146, 148, 150, 152, 154, 156) rotational movements and the adjustable track width involving the adjustable wheel connector's (150) movements along the sliding rod (154). This aspect aids in the decrease of the device's footprint for increased space inside the vehicle. It also plays increasing adaptability to the different types of vehicles presented and the environments where the repair is done. This will be explained further in future paragraphs and FIGS. 2, 4, and 5.

FIG. 2 illustrates a side and back view of the retractable small-engine-machine lifter in its fully retracted position. Sub-figure (a) is the side view of the retractable small-engine-machine lifter in a retracted position (200), where the support column (140), arm (106, 108), and support frame (118) are retracted into the vehicle's (102) interior. In this retracted position (200), the support column (104) fits inside the vehicle (102). The position of the support column (104) is caused by the retraction of the extension beam (102) into the fixed horizontal bracket (130). Cylinder rod (160) is retracted, ultimately pulling hydraulic cylinder (158), the support column (104), and extension beam (128) into the vehicle (102).

The arm assembly (104, 106, 108, 122, 128, 130) is also entirely retracted into the vehicle (102). In the lifter's retracted position (200), the arm (106, 108) is raised upward along a vertical sagittal plane. The upper link member's (106) inner end pivots upward along joint (110), and the lower link member's (108) inner end pivots upward along joint (112). The upper link member's (106) outer end pivots upward along joint (114), and the lower link member's (108) outer end pivots upward along joint (116). The support frame (118) and the lifter platform are horizontally leveled. The front edge of the support frame (118) is aligned with the edge of the vehicle's (102) rear. The lift platform is still positioned in line with the support frame (118) outside of the vehicle (102).

Cylinder rod (124) retracts into hydraulic cylinder (120) in the lifter's retracted position (200). The outer end of cylinder rod (124) pivots along joint (162) during retraction. Hydraulic cylinder (120) and its associated pivoting cover bracket (122) are horizontally flat, positioned perpendicular to the support column (104) and parallel to hydraulic cylinder (158), cylinder rod (160), the extension beam (128), and the fixed horizontal bracket (130); this pivot is done along joint (126) on the support column (104).

The hydraulic power unit (136) is electrically connected to a terminal (206) inside the vehicle (102) via a cable (204). The terminal (206) is connected to a wireless remote (202). A user presses a button on the remote (202), which instructs the terminal (206) to supply the hydraulic power unit (136) with electrical power via a connected cable (204) between the terminal (206) and the power unit (136). In turn, it triggers the power unit (136) to supply the pistons (120, 158) with hydraulic fluid via hydraulic hoses (132, 134).

It should be noted that the device is effectively fully retracted with the exception of the lifter platform. The device is considered to be in a fully retracted state when the lifter platform is rotated inward to fit in the interior space of the vehicle (102); this will be demonstrated in the next sub-figure.

Sub-figure (a) shows the two-stage dual-directional mechanism during retraction. The retraction upward can be done with one single action to increase service speed. The mechanism can also provide convenience to the user and for adapting to less ideal environments for repair work since the small engine machine on the platform can be brought to a preferred level. The sub-figure also shows the second aspect of the device, which is the very small footprint. First, the device is retracted into the vehicle (102), where the column (104) is a shorter distance from the hydraulic power unit (136). Second, the arm (106, 108) and the lifter platform are nearly aligned with the length of the support column (104). The distance between the link members of the arm (106, 108) and the support column (104) is smaller. The distance between the support frame (118) and the length of the column (104) is also smaller. Overall, the retracted state (200) only takes up a small portion of space within the vehicle (102) to provide increased space inside the vehicle (102).

The terminal (206) is presumed to be connected to an electrical power source within the vehicle (102), such as the battery. When powered, the terminal (206) receives instructions from the remote (202) to supply the power unit (136) with electricity in order to activate the device's two-stage dual-directional mechanism. At this time, the motor (140) activates, which triggers the extraction of hydraulic fluid from the reservoir (138) to the hydraulic cylinders (120, 158) via the hydraulic hoses (132, 134). For the terminal (206) to receive instructions from the remote (202), the latter needs to be in close enough proximity to send a signal. If it is too far away, the signal may be too weak for the terminal (206) to pick up, which means that the lifter won't function as a result.

The remote (202) in this figure is a general representation. In this figure, the remote (202) is illustrated with one ‘on’ button that moves the lifter when the button is held down. Additional buttons on the remote may include two additional buttons for dictating the direction of the lifter's movement (i.e., extension or retraction); one of these two buttons would be held down to dictate the extension or retraction. An additional button may be used to lock the lifter in place, so the user would not activate the lifter's movement even when pressing the ‘on’ button. It should also be noted that the remote (202) in the present disclosure is wireless. In another embodiment, the remote (202) may be wired to the terminal (204). The wire may be retractable or taped to the walls of the vehicle (102).

Sub-figure (b) illustrates a front view of the lifter in its retracted state (200) within the vehicle's (102) interior. More particularly, it is the front view of the lifter when facing the rear of the vehicle (102). The lifter is located on the left side of the vehicle's (102) interior. The switch (146) is a rectangular solid inside the support frame (118) that protrudes through an opening on the support frame's (118) right side. The switch (146) is pivoted on an angle and attached to a locking pin (210), located inside the support frame (118) behind the restraint gear (144). Unlike in sub-figure (a), the pivot segment (142) and the rest of the lifter platform are rotated 90 degrees inward from an extended position to a retracted position. Therefore, this sub-figure illustrates the lifter in its fully retracted position. The fixed and adjustable wheel connectors (148, 150) are held in place on the sliding rod (154), shown with the overlapping top sections of the connectors (148, 150). A workbench (208) is situated on the right side of the lifter and below the retracted lifter platform. The terminal (206) is clearly shown on top of the workbench (208), near the right side of the vehicle's (102) interior. The remote (202) is shown outside of the vehicle (102) on the right side.

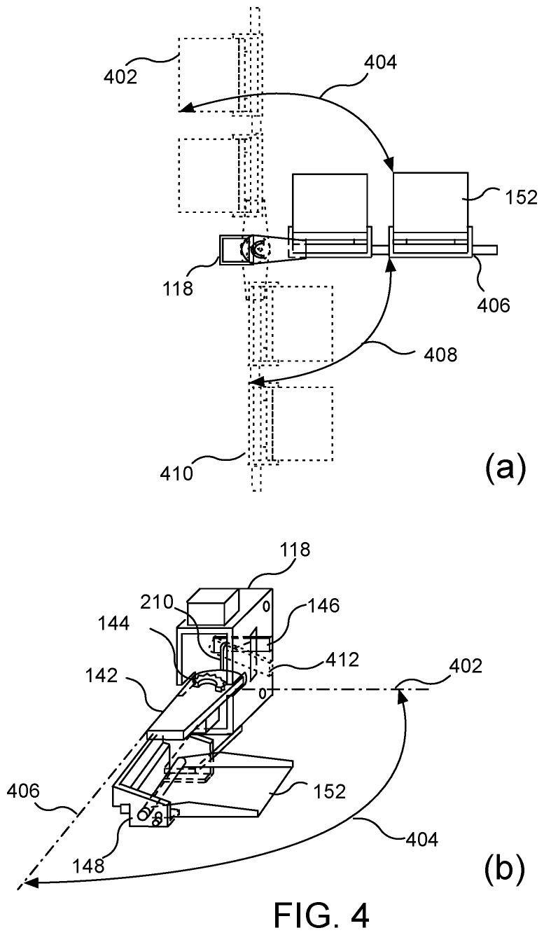

The lifter platform is locked into place and only rotates when the switch (146) and locking pin (210) are lifted. This releases the restraint gear (144) to allow the pivot segment (142) and the rest of the platform to rotate. This will be further illustrated and explained in FIG. 4.

With the lifter platform rotated in place to fit inside the vehicle's (102) interior space, the sub- figure further demonstrates the second aspect involving the small footprint to increase the interior space of the vehicle (102). Because the device is allocated to the left side of the vehicle's (102) interior (when facing the rear of the vehicle (102)), it allows for extra space inside that can be used for different purposes. In this embodiment of the present disclosure, the extra space is utilized with a workbench (208). In an alternative embodiment, this space can be just for storage. Since there is extra space above the workbench (208), the rotation of the lifter platform utilizes this space to fit compactly inside the rear of the vehicle (102). The lifter does not protrude from the rear edge of the vehicle (102), so the vehicle (102) doors can close normally. As a result, less space is wasted, and no compromise to the rest of the vehicle (102) is needed to make space for the device.

As a result of the small footprint and the resulting increased vehicle space, the implementation of the workbench (208) also provides increased convenience in that a user has better access to tools that would be normally kept in a brick-and-mortar shop.

The lifter device is situated on the left rear side of the vehicle (102). In an alternative embodiment, the device may be shifted to be aligned to the right side of the vehicle's (102) interior facing the rear of the vehicle. Modifications to the platform and the workbench (208) would likely be required to accommodate this embodiment. In yet another alternative embodiment, two lifter devices may be simultaneously implemented along both side walls of the vehicle's (102) interior. This alternative embodiment would allow two small engine machines to be repaired simultaneously. The platform of one lifter would be lower than the other. Additionally, the arm (106, 108) and column (104) of one device may be shorter than the other. Depending on the space available, the workbench (208) may or may not be present. In order to provide the increased convenience of a shop-like repair, a larger vehicle (102) like a truck may be required to accommodate two lifters and one workbench (208).

In an alternative embodiment, the entire lifter can be rotated further inward, where the lift platform is parallel to the vehicle's (102) left side wall. This may be done with a rotatable base on the floor for the column (104) to pivot around. However, this rotatable base may take up vertical space and affect the design. Furthermore, the workbench (208) may need to be modified or removed for this alternative embodiment.

FIG. 3 illustrates the side views of how the retractable lift arm assembly moves from one position to another using the two-stage dual-directional mechanism. Sub-figure (a) illustrates the retractable lift arm assembly being in the retracted position (200). All descriptions of the arm, column, pivoting cover bracket, and extension beam in FIG. 2 also apply here. In the retracted position (200), a column (104) is positioned in an initial column position (302), marked along the rear side of the column (104). An extension beam (128) is retracted to an initial beam position (304), marked along the front side of the extension beam (128), which is also aligned with the column's (104) initial column position (302). The arm (106, 108) is retracted at an upward angle in an initial arm position (306), marked along the top edge of the upper link member (106). A pivoting cover bracket (122) is positioned horizontally in an initial bracket position (308).

Sub-figure (b) illustrates the retractable lift arm assembly in an intermediate position as the lifter extends downward and outward. The user presses a button on the remote (200) to activate the retractable lift arm assembly. The support column (104) moves forward with a translational column movement (310) from the initial column position (302) to an intermediate column position (312). Looking at the sub-figure, the column (104) moves (310) forward from the right side to the left. The support column (104) can also move backward with a translational column movement (310) from the intermediate column position (312) to the initial column position (302). The extension beam (128) extends forward with a translational beam movement (314) from the initial beam position (304) to an intermediate beam position (316). The extension beam (128) can also move backward with a translational beam movement (314) from the intermediate beam position (316) to the initial beam position (304). Both the column (104) and the extension beam (128) move based on the hydraulic cylinder (158) and the extension or retraction of its rod (160).

At the same time, the arm (106, 108) starts moving downward with a rotational arm movement (318) from the initial arm position (306) to an intermediate arm position (320). In doing so, the upper link member's (106) inner end pivots downward along joint (110), and the lower link member's (108) inner end pivots downward along joint (112). The arm (106, 108) can also move upward with a rotational arm movement (318) from the intermediate arm position (320) to an initial arm position (306). This movement is caused by the extension or retraction of cylinder rod (124) from hydraulic cylinder (120); the outer end of rod (124) pivots along joint (162), which is attached to the upper link member (106).

The rod's (124) movement is dictated by hydraulic cylinder (120) and the movement of the pivoting cover bracket (122). The pivoting cover bracket (122) moves upward with a rotational bracket movement (322) from the initial bracket position (308) to an intermediate bracket position (324). The pivoting cover bracket (122) pivots upward along joint (126). The hydraulic cylinder (120) associated with rod (124) rotates along with the pivoting cover bracket (122) since it is located within the component. The pivoting cover bracket (122) can also move downward with a rotational bracket movement (322) from the intermediate bracket position (324) to an initial bracket position (308).

Sub-figure (c) illustrates the retractable lift arm assembly in a final position as the lifter transitions to the fully extended position (100). All descriptions of the arm, column, pivoting cover bracket, extension beam, joints, hydraulic cylinders, and rods in FIG. 1 also apply here. The user continues to use the remote (202) to bring the lifter further outward and downward to a fully extended position (100). Once the fully extended position (100) is achieved, activating the remote (202) will do nothing until the remote (202) settings are adjusted to retract the device (e.g., via a directional button). The support column (104) moves farther forward with a translational column movement (326) from the intermediate column position (312) to the final column position (328). The support column (104) can also move backward with a translational column movement (326) from the final column position (328) to the intermediate column position (312). The extension beam (128) extends farther forward with a translational beam movement (330) from the intermediate beam position (316) to a final beam position (332). The extension beam (128) can also move backward with a translational beam movement (330) from the final beam position (332) to the intermediate beam position (316). Both the column (104) and the extension beam (128) move based on the hydraulic cylinder (158) and the extension or retraction of its rod (160).

At the same time, the arm (106, 108) moves farther downward with a rotational arm movement (334) from the intermediate arm position (320) to a final arm position (336). As noted before, the upper link member's (106) inner end pivots downward along joint (110), and the lower link member's (108) inner end pivots downward along joint (112). The arm (106, 108) can also move upward with a rotational arm movement (334) from the final arm position (336) to the intermediate arm position (320). This movement is caused by the extension or retraction of cylinder rod (124) from hydraulic cylinder (120); the outer end of rod (124) pivots along joint (162), which is connected to the upper link member (106).

The pivoting cover bracket (122) moves upward with a rotational bracket movement (338) from the intermediate bracket position (324) to a final bracket position (340). The pivoting cover bracket (122) pivots upward along joint (126). The hydraulic cylinder (120) associated with rod (124) rotates along with the pivoting cover bracket (122) since it is located within the component. The pivoting cover bracket (122) can also move downward with a rotational bracket movement (338) from the final bracket position (340) to the intermediate bracket position (324).

FIG. 4 illustrates how the adjustable lifter platform works in one embodiment of the present disclosure. Sub-figure (a) illustrates a top view of the lifter platform rotating around a support frame (118), primarily from a retracted inward position to a new retracted outward position for a 180-degree rotation. The support frame (118) is oriented, with the front side facing the right in the sub-figure. The lifter platform starts in a retracted inward position (402), where the trays (152) would be facing inward (to the left in this figure), which is opposite of the front of the support frame (118). The lifter platform then rotates along the front edge of the support frame (118). The platform rotates with a rotational platform movement (404) from the retracted inward position (402) to an extended position (406). Here, the trays (152) in the platform's extended position (406) are parallel to the front side of the support frame (118). The platform can also rotate with a rotational platform movement (404) from the extended position (406) to the retracted inward position (402). From the extended position (406), the platform can then move with a rotational platform movement (408) from the extended position (406) to a new retracted outward position (410). The retracted outward position (410) is where the trays (152) are facing in the same direction (facing right in the figure) as the front of the support frame (118). Likewise, the platform in a retracted outward position (410) can move with a rotational platform movement (408) back to the extended position (406). Overall, the lifter platform can rotate 180 degrees along a horizontal transverse plane.

The rotational platform movements (404, 408) of the platform in this sub-figure demonstrate one of the features related to the lifter's third aspect, the adjustability of the platform. With this feature of the third aspect, the device can rotate its platform as a means to increase the adaptability for repair work on small engine machines. Specifically, the rotation of the platform can be used to adapt to less ideal environments. One way it does this by rotating to avoid obstructions like debris or incoming traffic. Additionally, the rotational platform movements (404, 408) can be done to obtain better lighting in the repair environment. In another scenario, the platform can be rotated toward shade under the tree during a hot summer day. By increasing the adaptability to less ideal environments, the user does not have to move to a different location with the small engine machine in tow. As a result, increased service speed can also be achieved.

Sub-figure (b) illustrates a partial perspective view of the lifter platform from the support frame to the outer end of the fixed wheel connector (148); all descriptions of the applicable components in previous figures also apply here. All descriptions of the rotational platform movement (404) from the retracted inward position (402) to the extended position (406) in sub-figure (a) also apply here.

The rotational platform movement (404) can only be done when the switch (146) is raised from its initial pivoted position (412). The switch (146) pivots along its inner end inside the support frame (118). The locking pin (210) is also lifted up due to its attachment to the switch (146). The restraint gear (144) on the upper section of the pivot segment (142) is then free to rotate along the front edge of the support frame (118). As a result, the pivot segment (142), the restraint gear (144), fixed wheel connector (148), and tray (152) rotate with a rotational platform movement (404) from the platform's retracted inward position (402) to the extended position (406). Both positions (402, 406) are shown to be aligned with the edge of the pivot segment's (142) upper section. Likewise, the platform can rotate with a rotational platform movement (404) from the platform's extended position (406) to the retracted inward position (402). As long as the switch (146) and locking pin (210) are held up manually, the platform can rotate as much as the user desires. When the platform is rotated to a desired angle, the user releases the switch (146). This lowers the switch (146) and locking pin (210) back to their original positions. The restraint gear (144) is locked in place, and the platform can no longer rotate until the switch (146) is lifted up again.

The rotational platform movements (404, 408) for adjusting the platform angle are done manually. In an alternative embodiment, the platform can be electrically powered to rotate automatically. The support frame (118) may be powered electrically or operate with computer programming. The switch (146) may be removed or modified to be more compact and operate entirely within the support frame (118). This alternative embodiment provides increased convenience since the user does not have to put any effort into rotating the platform. Furthermore, the adaptability for repair work is also increased because the user may be able to adjust the platform even when a small engine machine is already on the platform and lifted up from the ground.

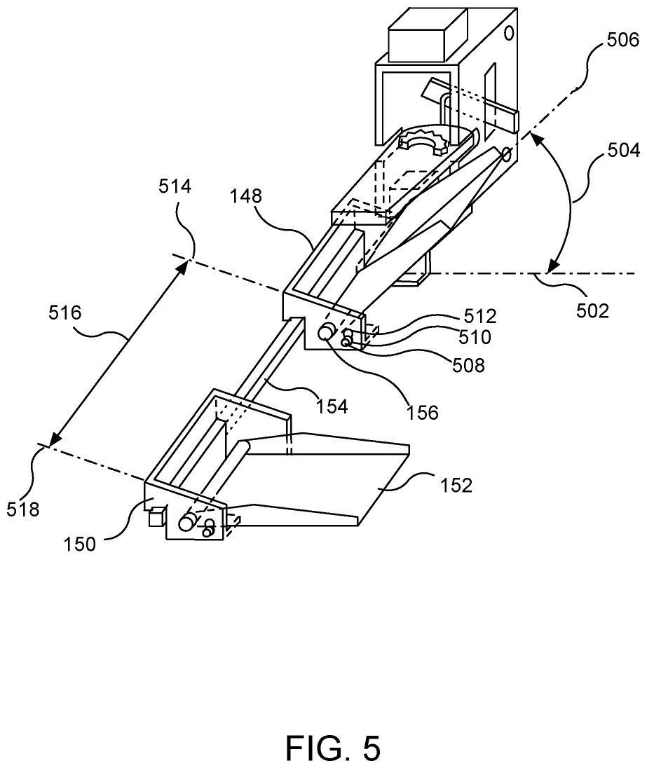

FIG. 5 illustrates a perspective view of the trays in the lifter platform is adjusted in one embodiment of the present disclosure. All descriptions of the lifter platform in previous figures also apply here. A tray (152) connected to the fixed wheel connector (148) is shown to pivot from a flat level to an upward angle. The tray (152) starts at an initial tray position (502). The tray (152) is manually pivoted with a pivoting tray movement (504) to a final tray position (506). Both tray positions (502, 506) are aligned with the tray's (152) bottom edge closer to the pivot segment (142) and support frame (118). The tray (152) pivots along the locking rod (156), which is shown to protrude from the outer side of the fixed wheel connector (148). The tray (152) can also pivot with a pivoting tray movement (504) from the final tray position (506) to the initial tray position (502). When the tray (152) is pivoted to a maximum upward angle, a locking pin (508) is placed into an upper locking pin slot (512) to lock the tray (152) in the final tray position (506). If the user wants to secure the tray (152) in its initial tray position (502), the locking pin (508) can be removed and placed in the lower locking pin slot (510).

The figure also demonstrates the track width adjustment of the connectors (148, 150) and trays (152). More specially, the adjustable wheel connector (150) slide along the sliding rod (154) away from the rest of the platform. An associated tray (152) is connected to the adjustable wheel connector (150), so it moves along with the adjustable wheel connector (150). Therefore, any mention of the adjustable wheel connector's (150) movement also implies its associated tray's (152) movement. The adjustable wheel connector (150) starts at an initial connector position (514). The adjustable wheel connector (150) slides outward with a translational connector movement (516) to a final connector position (518). Both connector positions (514, 518) are aligned with the top edge of the adjustable wheel connector (150) that can make physical contact with the fixed wheel connector (148). The adjustable wheel connector (150) can also slide inward with a translational connector movement (516) from its final connector position (518) back to its initial position (514).

The pivoting of the trays (152) is one of the features relating to the third aspect of the present disclosure—the adjustability of the platform. This pivoting feature achieves increased adaptability for repair work. Specifically, the pivoting of the trays (152) can be prearranged to the final tray position (506) prior to a small engine machine being loaded onto the platform. By doing this, the wheels of the machine can be secured onto the platform to prevent the machine from falling off when the platform is lifted. Those skilled in the arts will find it is obvious that additional safety straps would be used to wholly secure the machine onto the platform.

The connectors (148, 150) have two locking pin slots (510, 512) for adjusting the tray in two positions (502, 506). In an alternative embodiment, additional locking pin slots may be implemented on the side of the connector (148, 150) to allow for additional pivot positions for the tray (152).

The sliding of the adjustable wheel connector (150) and tray (152) is another feature relating to the third aspect of the present disclosure. This pivoting feature achieves increased adaptability for repair work. Specifically, the track width adjustment means that a greater number of small engine machines with different track widths can be brought onto the platform to be repaired. This track width adjustment also comes in handy in the second aspect of the present disclosure—the small footprint. Because the adjustable wheel connector (150) can move toward the rest of the platform to the point of physical contact, the platform itself takes up less space and provides a slight increase in the vehicle's interior space.

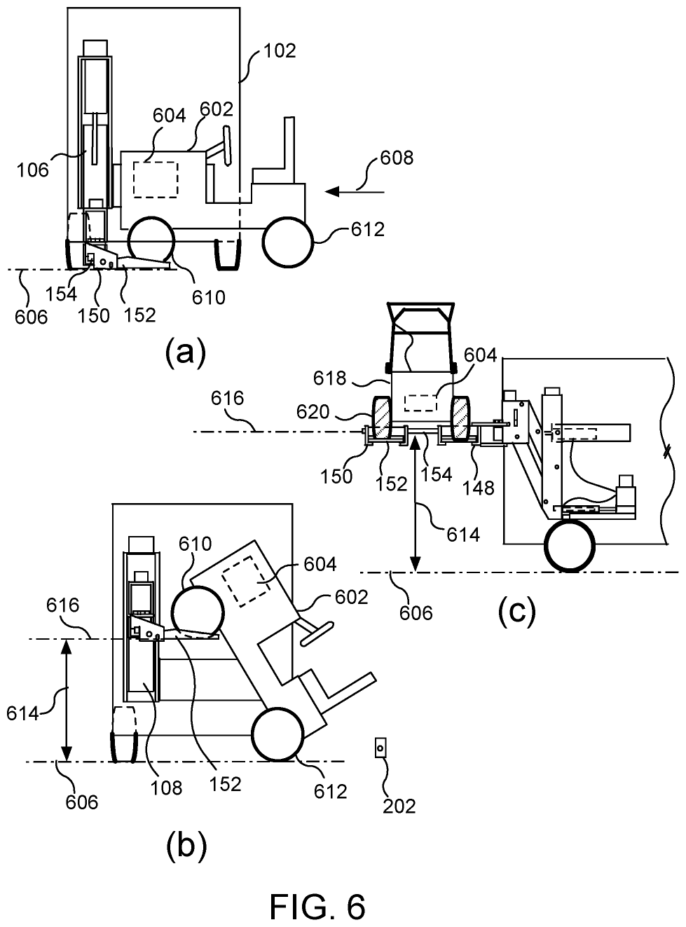

FIG. 6 illustrates how a retractable lifter of the present disclosure loads and elevates small engine machines for onsite repairs. Sub-figure (a) illustrates a front view of the lifter platform extended to the ground in order to load a lawn mower tractor (602) on the platform. The lifter is in an extended position at the rear of a service vehicle (102). The arm, shown with the upper link member (106), is positioned downward. The platform is positioned at a ground-level position (606), shown to line up with the base of the trays (152). The lawn mower tractor (602) is a vehicle-sized small engine machine with an engine (604) that needs repair. The engine (604) is accessible from the underside of the tractor (602). Because the lawn mower tractor (602) is particularly large, the track width of the platform is adjusted by moving the adjustable wheel connector (150) and associated tray (152) along the sliding rod (154) to widen the platform's track width. The tractor (602) then moves in a direction (608) toward the platform. The tractor (602) stops moving when its front wheels (610) are loaded and secured onto the trays (152). The rear wheels (612) of the tractor (602) remain on the ground. It is obvious to those skilled in the art that the wheels (612) on the platform need to be secured onto the platform via safety straps and the pivot of the trays (152).

Sub-figure (b) illustrates the lifter raising the front track of the tractor (602) to an appropriate level for repair. A user activates the remote (202) to raise the arm, shown with the lower link member (108) in this sub-figure. At the same time, the platform and associated trays (152) lifts the front wheels (610) of the tractor (602), effectively angling the tractor's (602) front side. The platform moves with a vertical movement (614) from the ground level position (606) to an elevated position (616). The user can now go under the tractor's (602) underside to repair the engine (604). When the repair is complete, the user activates the remote (202) to vertically move (614) the arm (118) and platform downward from the elevated position (616) to the ground level position (606). The tractor (602) can then move away from the trays (152) of the platform.

The elevated position (616) can be at any height above the ground level position (606), depending on how much the arm (106, 108) and platform retract. This elevated position (616) can be adjusted based on the user's preference, the type of machine, and the type of repair needed, which improves the overall convenience of repairs for the user.

The tractor (602) is shown with the front wheels loaded onto the lifter platform. In an alternative embodiment, the tractor (602) can be loaded onto the platform by loading the rear wheels (612) onto the platform instead. This would be done if repairs need to be done on the rear side of the tractor (602) instead (e.g., rear axle repair or wheel repair).

Sub-figure (c) illustrates the side view of the lifter in a retracted position. All descriptions of the connectors, trays, and sliding rod in previous figures also apply here. The platform is positioned outward, lifting a small engine machine (618). This small engine machine (618) may be a lawn mower or snow blower. In this case, the sub-figure shows a front view of the small engine machine (618) being a two-wheeled machine with its handle on the other side of the platform. Prior to elevating the platform, the adjustable wheel connector (150) and associated tray (152) would move outward along the sliding rod (154) to accommodate the wheels (620) and track width of the machine (618). After, the small engine machine (618) would be reversed onto the platform, loading its wheels (620) onto the platform trays (152). Finally, the platform is elevated to repair the machine (618). Furthermore, the connectors (148, 150) are wide apart to allow for direct access to the machine's (618) underside. In this case, the user can access the underside of the machine (618) to repair its engine (604). The wheels (620) of the machine (618) are loaded right on top of the trays (152). It is obvious to those skilled in the art that the wheels (620) need to be secured onto the platform via safety straps and the pivot of the trays (152).

The small machine (618) in this sub-figure is shown with two wheels, meaning that the machine (618) can be fully loaded onto the platform. A small four-wheeled machine (618) may also fit wholly on top of the platform. In the event that not all four wheels (620) can fit on top of the trays, the front or back wheels (620) may hop over the top edges of the connectors (148, 150) to float freely, while the other set of wheels (620) is set on the top of the trays (152).

In an alternative embodiment of the present disclosure, the trays (152) may accommodate machines with a longer wheelbase. This can be done to wholly fit a small- to medium-sized machine (618) onto the platform without the need to hop one set of wheels over the connectors (148, 150). The platform can still contribute to the second aspect—the small footprint—by redesigning the trays (152) to have foldable segments. In another sense, this alternative embodiment would also better secure the wheels (620) of a small engine machine (618) since an outer tray (152) segment can fold upward, keeping the wheels (620) in place.

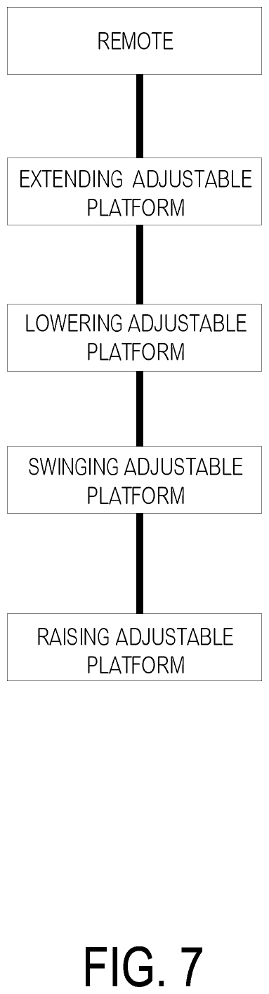

FIG. 7 shows a representative view of the retractable lifter method that includes but is not limited to the following steps: pressing buttons on the remote activating the hydraulic system to send hydraulic fluid to the hydraulic cylinders; extending the adjustable platform away from the vehicle storage area by extending the hydraulic cylinders; lowering the adjustable platform with the hydraulic cylinders; swinging the adjustable platform into position by rotating the adjustable platform by raising the switch, positioning the angle of the adjustable platform and lowering the switch allowing the locking pin to engage the restraint gear on the pivot segment; loading a small engine machine's front wheels onto the trays; and raising the adjustable platform using the hydraulic cylinders once again thereby raising the small engine machine and allowing room for a mechanic to work there beneath.

What is claimed is:

1. A retractable lifter fitting inside an existing vehicle for on-the-spot, small engine machine repairs comprising the following parts:
a) a hydraulic system;
b) an arm assembly;
c) an adjustable lifter platform; and
d) a wireless remote.

2. The retractable lifter fitting inside an existing vehicle for on-the-spot, small engine machine repairs of claim 1, wherein the hydraulic system having at least two, cylinder rods connecting the arm assembly to the adjustable lifter platform.

3. The retractable lifter fitting inside an existing vehicle for on-the-spot, small engine machine repairs of claim 1, wherein the hydraulic system having a hydraulic power unit with electric motor supplying hydraulic oil to the cylinders.

4. The retractable lifter fitting inside an existing vehicle for on-the-spot, small engine machine repairs of claim 1, wherein the hydraulic system having a reservoir holding hydraulic oil.

5. The retractable lifter fitting inside an existing vehicle for on-the-spot, small engine machine repairs of claim 1, wherein the hydraulic system having hydraulic hoses connecting to the power unit and delivering hydraulic oil to the hydraulic cylinders.

6. The retractable lifter fitting inside an existing vehicle for on-the-spot, small engine machine repairs of claim 1, wherein the arm assembly having an upper link member and lower link member connecting the hydraulic system to the adjustable lifter platform.

7. The retractable lifter fitting inside an existing vehicle for on-the-spot, small engine machine repairs of claim 1, wherein the arm assembly having a support column connecting the upper link member and lower link member to the hydraulic system with joints.

8. The retractable lifter fitting inside an existing vehicle for on-the-spot, small engine machine repairs of claim 1, wherein the adjustable lifter platform connecting to the arm assembly with a frame support.

9. The retractable lifter fitting inside an existing vehicle for on-the-spot, small engine machine repairs of claim 1, wherein the adjustable lifter platform having a fixed connector and an adjustable connector with trays.

8. The retractable lifter fitting inside an existing vehicle for on-the-spot, small engine machine repairs of claim 1, wherein the adjustable lifter platform having a pivot segment connecting trays to the frame support. The retractable lifter fitting inside an existing vehicle for on-the-spot, small engine machine repairs of claim 1, wherein the adjustable lifter platform having a sliding rod connecting the adjustable connector to the fixed connector.

11. The retractable lifter fitting inside an existing vehicle for on-the-spot, small engine machine repairs of claim 1, wherein the adjustable lifter platform having a switch on the frame support connecting a locking pin to a restraint gear on the pivot segment.

12. The retractable lifter fitting inside an existing vehicle for on-the-spot, small engine machine repairs of claim 1, wherein the adjustable lifter platform having locking rods and locking pins connecting trays to the adjustable connector and fixed connector.

13. The retractable lifter fitting inside an existing vehicle for on-the-spot, small engine machine repairs of claim 1, wherein the adjustable lifter platform having sliding rod connecting the adjustable connector to the fixed connector.

14. The retractable lifter fitting inside an existing vehicle for on-the-spot, small engine machine repairs of claim 1, wherein the remote having buttons controlling the hydraulic arm assembly and hydraulic system. A method of performing on-the-spot, small engine machine repairs comprising the following steps:
a) providing the hydraulic system of claim 1;
b) providing the arm assembly of claim 1;
c) providing the adjustable lifter platform of claim 1;
d) providing the wireless remote of claim 1;
e) pressing buttons on the remote activating the hydraulic system;
f) extending the adjustable platform away from a vehicle;
g) lowering the adjustable platform;
h) swinging the adjustable platform into position using the switch.
h) loading a small engine machine's front wheels onto the trays; and
j) raising the adjustable platform.

16. The method of performing on-the-spot, small engine machine repairs of claim 15, wherein the swinging the adjustable platform includes the step of raising the switch, positioning the angle of the adjustable platform and lowering the switch allowing the locking pin to engage the restraint gear on the pivot segment.
